(19) United States
(12) Patent Application Publication
(10) Pub. No.: US 2006/0013092 A1
(43) Pub. Date: Jan. 19, 2006

(54) Method and apparatus for aligning a substrate, method and apparatus for inspecting a defect on a substrate using the aligning method and apparatus

(76) Inventors: Sung-Man Lee, Gyeonggi-do (KR); Byung-Am Lee, Gyeonggi-do (KR); Byung-Seol Ahn, Gyeonggi-do (KR); Jae-Sun Cho, Gyeonggi-do (KR); Chang-Hoon Lee, Chungcheongnam-do (KR); Young-Kyu Lim, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/177,870

(22) Filed: Jul. 8, 2005

(30) Foreign Application Priority Data
Jul. 15, 2004 (KR) 2004-55063

(51) Int. Cl. G11B 7/00

(52) U.S. Cl. 369/53.1; 369/44.27; 369/47.1

(57) ABSTRACT

A method of aligning a substrate can comprise primarily aligning the substrate having a pattern, obtaining pattern information corresponding to a configuration of the pattern, comparing the pattern information with predetermined reference pattern information to corroborate the acceptability of the pattern information, selectively exchanging the predetermined reference pattern information with the pattern information based on the acceptability of the pattern information, and secondarily aligning the substrate to correlate the position of the pattern with the pattern information.

### CROSS REFERENCE TO RELATED APPLICATION

This application claims priority under 35 USC § 119 to Korean Patent Application No. 2004-55063, filed on Jul. 15, 2004, the contents of which are herein incorporated by reference in its entirety for all purposes.

### BACKGROUND OF THE INVENTION

1. Field of the Invention

The present invention relates to a method and an apparatus for aligning a substrate, and to a method and an apparatus for inspecting a defect on a substrate using the aligning method and apparatus. More particularly, the present invention relates to a method of aligning a substrate, an apparatus for performing the aligning method, a method of inspecting a defect on a substrate, and an apparatus for performing the inspecting method using the aligning method.

2. Description of the Related Art

Generally, a semiconductor device is manufactured under surroundings that include various contamination sources such as particles in air, contaminants generated from process equipment, reactants and/or products, etc. Thus, it is very difficult to find the contamination sources functioning as defects of the semiconductor device when performing hundreds of processes for manufacturing a semiconductor device.

Recently, as semiconductor devices have become highly integrated and miniaturized, contamination caused by minute particles that are not previously considered as important an issue in non-highly-integrated past semiconductor devices, has become a significant problem regarding capacity and yield of modem semiconductor devices.

Meanwhile, the following equation may represent a relation between a defect generated by a particle and a yield of a semiconductor device:
Y=Exp(−DA)

In the equation, Y indicates the yield, D indicates the density of the particles, and A indicates the area of the circuit region. It shall be noted that according to the above equation, the yield Y is reduced proportionally to increased numbers of the particles on a semiconductor chip.

In general, it is required to remove particles having a size of up to about 0.3 μm in a 4M dynamic random access memory (DRAM) device. However, as a semiconductor device has become highly integrated, the ability to remove relatively minute particles is more important. For example, it is required to remove particles of a size of up to about 0.1 μm in a 256M-DRAM. Thus, since a defect of a semiconductor device caused by the presence of these particles is increased proportionally to the diminishing size of the particles to be removed, the yield of semiconductor devices is remarkably reduced due to the presence of the particles. To improve the yield of highly-integrated semiconductor devices such as 256M-DRAM, the ability to strictly manage the particles is quite important.

Methods of inspecting particles on a substrate may be classified into methods using a lamp and methods using a laser, respectively. Since the methods using the lamp have a low precision they have not been significantly used recently. Thus, the methods using the laser have recently been principally used.

In a conventional method of inspecting a particle on a substrate using a laser, the substrate having a pattern is positioned on the stage of an inspection tool. The substrate is then primarily aligned on the stage. The laser is irradiated onto the substrate to obtain a reference image from a laser scattered from the substrate in which particles having numbers within an acceptable predetermined range exist. The pattern of the substrate is secondarily aligned using the reference image. In the secondary alignment process, each of the pattern images is aligned with the reference image. The secondary alignment process is referred to as a registration alignment. An inspection region is set up on the substrate by the secondary alignment. The inspection region is scanned with a laser to obtain an image of the inspection region. The image of the inspection region is compared with the reference image to determine whether or not the number of particles in the inspection region is within the acceptable predetermined range.

According to the conventional method, the reference image obtained from the first substrate is continuously used for inspecting particles on following substrates. Thus, when the following substrates are inspected, the process for obtaining the reference image is omitted.

However, although patterns are formed on each of the substrates under substantially same processing conditions, each of the patterns on the substrates does not have substantially the same configuration. That is, each of the patterns may have configurations that are different from each other. As a result, the reference image obtained from the first substrate can be different from the pattern image of a following substrate.

When the above-mentioned situation occurs, an inspection tool is employed to determine whether the substrate is abnormal in the secondary alignment process. The substrate determined to be abnormal would not pass scrutiny in the secondary alignment process. Thus, the abnormal substrate is unloaded from the inspection tool so that the process for inspecting particles on that substrate is not carried out.

The abnormal substrate does not have an abnormal pattern. It has a normal pattern having a configuration which is slightly different from the reference image. However, in the conventional method, the process for inspecting particles is not performed on the abnormal substrate.

Therefore, after a reference image of the substrate determined to be abnormal is obtained, the above-mentioned processes are repeatedly carried out. That is, the primary alignment process and the secondary alignment process are performed from the beginning.

In particular, the process for inspecting particles is always carried out on hundreds of processes for manufacturing a semiconductor device. Thus, repeatedly performing the primary and secondary alignment processes from the beginning results in a substantial time loss in manufacturing the semiconductor device.

### SUMMARY OF THE INVENTION

The present invention provides an apparatus and a method of aligning a substrate that is capable of preventing a substrate having a normal pattern from being determined to be abnormal, for performing a secondary alignment process on the substrate.

The present invention also provides an apparatus for performing the above-mentioned aligning method.

The present invention still also provides a method of inspecting a defect on a substrate using the above-mentioned aligning method.

The present invention yet still also provides an apparatus for performing the above-mentioned inspecting method.

An apparatus for aligning a substrate can be provided. The apparatus comprises a first aligning unit for primarily aligning the substrate having a pattern. It also can include a pattern information-processing unit for processing pattern information with respect to the pattern, reference pattern information being set up in the pattern information-processing unit. A unit can also be employed for comparing the pattern information with the reference pattern information to selectively exchange the reference pattern information for the pattern information. A second aligning unit can be included for secondarily aligning the substrate to correlate the position of the pattern with the pattern information.

A method of aligning a substrate can also be provided. The method can comprise primarily aligning the substrate having a pattern, obtaining pattern information corresponding to a configuration of the pattern, comparing the pattern information with predetermined reference pattern information to corroborate the acceptability of the pattern information, selectively exchanging the predetermined reference pattern information with the pattern information based on the acceptability of the pattern information, and secondarily aligning the substrate to correlate the position of the pattern with the pattern information. The method of primarily aligning the substrate preferably comprises providing a plurality of first alignment points having a first width on the substrate, moving the substrate to align the first alignment points with a predetermined first coordinate, providing a plurality of second alignment points having a second width narrower than the first width on the substrate, and moving the substrate to align the second alignment points with a predetermined second coordinate. The predetermined reference pattern information and the pattern information preferably comprise an image or a light signal profile.

Another method of aligning a substrate can also be present. That method can comprise primarily aligning a first substrate having a first pattern, obtaining reference pattern information corresponding to a configuration of the first pattern, secondarily aligning the first substrate to correlate the position of the first pattern with the reference pattern information, primarily aligning a second substrate having a second pattern, obtaining pattern information corresponding to a configuration of the second pattern, comparing the pattern information with the reference pattern information to corroborate the acceptability of the pattern information, selectively exchanging the reference pattern information with the pattern information based on the acceptability of the pattern information, and secondarily aligning the substrate to correlate the position of the pattern with the pattern information. The step of primarily aligning the first and second substrates preferably comprises setting up a plurality of first alignment points having a first width on the first and second substrates, moving the first and second substrates to align the first alignment points with a predetermined first coordinate, setting up a plurality of second alignment points on the first and second substrates having a second width narrower than the first width, and moving the first and second substrates to align the second alignment points with a predetermined second coordinate.

A method of inspecting a defect on a substrate can also be presented. The method can comprise primarily aligning the substrate having a pattern, obtaining pattern information corresponding to a configuration of the pattern, comparing the pattern information with predetermined reference pattern information, exchanging the reference pattern information with the pattern information in accordance with comparison results, secondarily aligning the substrate to correlate the position of the pattern with the pattern information, and determining whether the defect exists on the substrate in accordance with the pattern information. When the reference pattern information and the pattern information preferably comprises an image, the method of determining whether the defect exists on the substrate can comprise setting up an inspection region on the substrate, obtaining an image corresponding to the inspection region, and comparing the image of the inspection region with the pattern information to determine whether the defect exists on the inspection region. When the reference pattern information and the pattern information comprises a light signal profile, the method of determining whether the defect exists on the substrate can comprise setting up an inspection region on the substrate, obtaining a light signal profile corresponding to the inspection region, and comparing the light signal profile with the pattern information to determine whether the defect exists on the inspection region.

Another preferred method of inspecting a defect on a substrate can comprise primarily aligning a first substrate having a first pattern, obtaining reference pattern information corresponding to a configuration of the first pattern, secondarily aligning the first substrate to correlate the position of the first pattern with the reference pattern information, determining whether the defect exists on the first substrate in accordance with the reference pattern information, primarily aligning a second substrate having a second pattern, obtaining pattern information corresponding to a configuration of the second pattern, comparing the pattern information with the reference pattern information, selectively exchanging the reference pattern information with the pattern information in accordance with the comparison results, secondarily aligning the substrate to correlate the position of the pattern with the pattern information, and determining whether the defect exists on the second substrate in accordance with the pattern information.

When the reference pattern information comprises an image, the method for determining whether the defect exists on the first substrate can preferably comprise setting up a first inspection region on the first substrate, obtaining a first image corresponding to the first inspection region, and comparing the first image with the reference pattern information to determine whether the defect exists on the first inspection region. In another preferred method wherein the pattern information comprises an image, determining whether the defect exists on the second substrate can comprise setting up a second inspection region on the second substrate, obtaining a second image corresponding to the second inspection region, and comparing the second image with the pattern information to determine whether the defect exists on the second inspection region.

When the reference pattern information comprises a light signal profile, the method for determining whether the defect exists on a first substrate preferably comprises setting up a first inspection region on the first substrate, obtaining a first light signal profile corresponding to the first inspection region, and comparing the first light signal profile with the reference pattern information to determine whether or not the defect exists on the first inspection region. In another preferred method wherein the pattern information comprises a light signal profile, determining whether the defect exists on the second substrate can comprise setting up a second inspection region on the second substrate, obtaining a second light signal profile corresponding to the second inspection region, and comparing the second light signal profile with the pattern information to determine whether the defect exists on the second inspection region.

### BRIEF DESCRIPTION OF THE DRAWINGS

The above and other features and advantages of the invention will become readily apparent by reference to the following detailed description when considered in conjunction with the accompanying drawings wherein:

FIG. 1 is a flow chart illustrating a method of aligning a substrate in accordance with a first embodiment of the present invention;

FIGS. 2 and 3 are plan views illustrating a substrate that is primarily aligned;

FIG. 4 is a plan view illustrating the substrate that is secondarily aligned;

FIG. 5 is an enlarged plan view illustrating a portion V in FIG. 4;

FIG. 6 is a flow chart illustrating a method of aligning a substrate in accordance with a second embodiment of the present invention;

FIG. 7 is a block diagram illustrating an apparatus for aligning a substrate in accordance with a third embodiment of the present invention;

FIGS. 8 and 9 are a flow chart illustrating a method of inspecting a defect on a substrate in accordance with a fourth embodiment of the present invention;

FIGS. 10 and 11 are a flow chart illustrating a method of inspecting a defect on a substrate in accordance with a fifth embodiment of the present invention; and

FIG. 12 is a block diagram illustrating an apparatus for inspecting a defect on a substrate in accordance with a sixth embodiment of the present invention.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

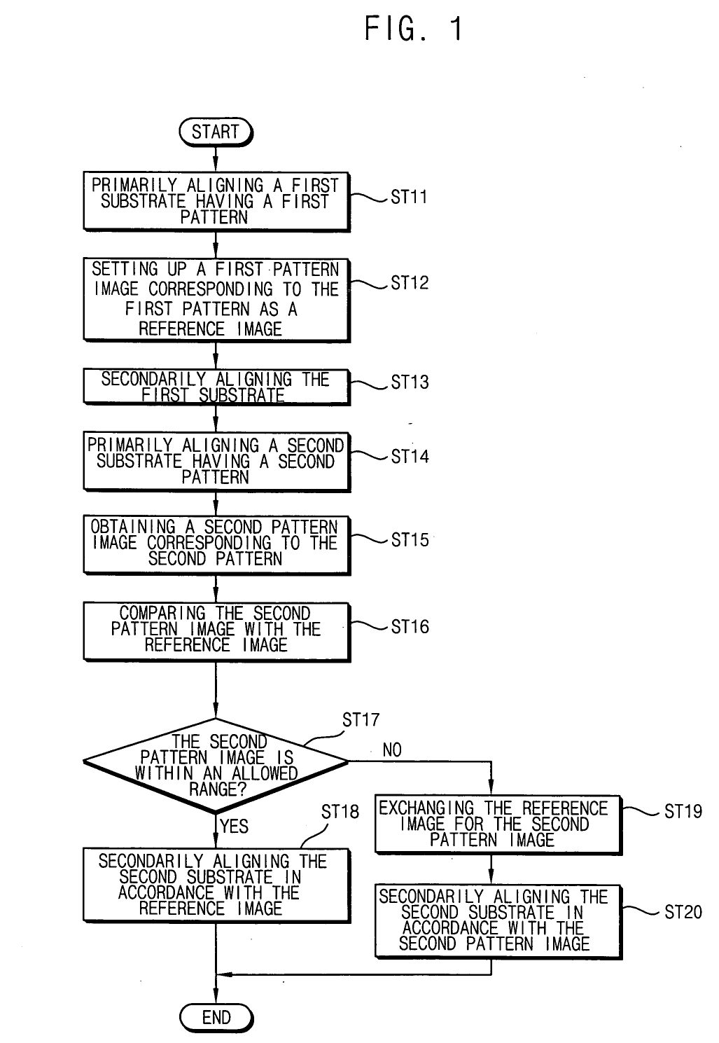

Referring to FIG. 1, in step ST11, a first substrate having a first pattern is positioned on a stage of an inspection tool. The first substrate is then primarily aligned on the stage. Here, a position and an angle of the first substrate are accurately aligned on the stage for performing a particle-inspecting process by the primary alignment process.

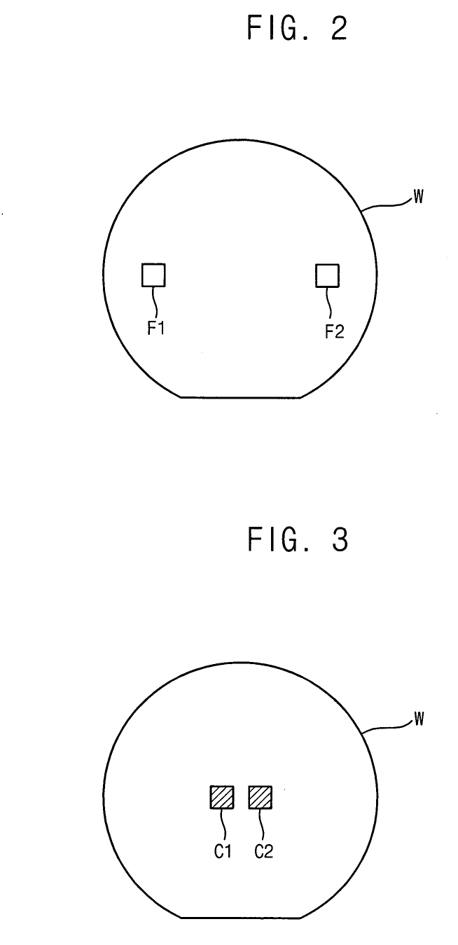

The first primary process may include the following two steps: With reference to FIG. 2, first alignment points F1 and F2 having a first width is set up on the first substrate W. The first alignment points F1 and F2 are aligned with a first coordinate set up in the inspection tool to primarily adjust the position and the angle of the first substrate W. This process is referred to as a fine alignment.

Referring to FIG. 3, second alignment points C1 and C2 having a second width narrower than the first width are set up on the first substrate W. The second alignment points C1 and C2 are aligned with a second coordinate in the inspection tool to secondarily adjust the position and the angle of the first substrate W. This process is referred to as a coarse alignment.

Referring now to FIG. 1, in step ST12, a laser is irradiated onto the first pattern. The inspection tool receives a laser reflected from the first pattern. The laser received in the inspection tool is converted into an image signal to obtain a first pattern image corresponding to the image signal. The first pattern image is set up as a reference image in the inspection tool. Here, an example of the laser is an argon laser having a wavelength of about 488 nm.

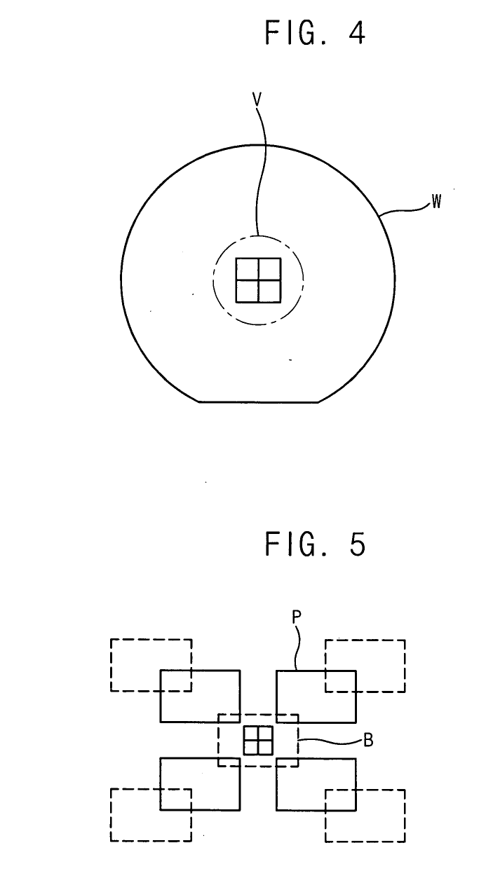

In step ST13, the first substrate is secondarily aligned to match the first pattern image with the reference image. With reference to FIGS. 4 and 5, in the secondary alignment process, a template box B of the inspection tool is positioned on the first pattern P corresponding to the reference image. Since the first pattern image is obtained from the first pattern P of the first substrate W, a configuration of the first pattern image may be substantially identical to that of the reference image. Thus, the first substrate W is moved to align a position of the first pattern image with the reference image.

Referring now to FIG. 1, in step ST14, a second substrate having a second pattern is primarily aligned by a process substantially identical to that used for primarily aligning the first substrate.

In step ST15, a laser is irradiated onto the second pattern. A laser reflected from the second pattern is converted into an image signal to obtain a second pattern image.

In step ST16, a configuration of the second pattern image is compared with the reference image.

In step ST17, whether the configuration of the second pattern image is within a predetermined acceptable range with respect to the reference image is determined.

In step ST18, when the configuration of the second pattern is substantially identical to that of the first pattern, the second pattern image may have the configuration substantially identical to that of the reference image. The second substrate is moved by a secondary alignment process to align a position of the second pattern image with the reference image.

On the contrary, when the configuration of the second pattern image is substantially different from that of the reference image so that the configuration of the second pattern image is determined to be beyond the acceptable predetermined range, the reference image is exchanged for the second pattern image, with the second substrate being positioned on the stage. Thus, the second pattern image is set up in the inspection tool as a new reference image.

In step ST20, the second substrate is moved by a secondary alignment process to align a position of the second pattern image with the new reference image. Additionally, after the second substrate is aligned, the above-mentioned steps are performed on following substrates.

According to the present embodiment, although a pattern of a substrate has a configuration different from that of the reference image, the second alignment process may be continuously performed using the new reference image obtained from the substrate. Thus, unloading the substrate from the inspection tool and repeatedly performing the first and second alignment processes may not be needed.

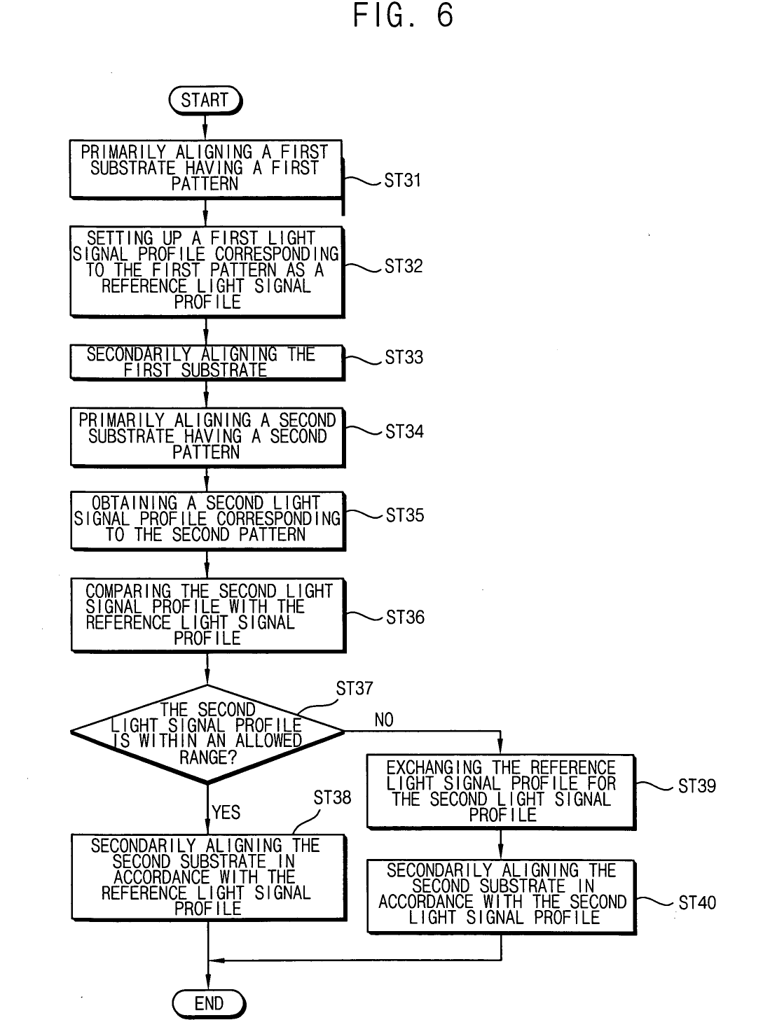

Referring to FIG. 6, in step ST31, a first substrate having a first pattern is positioned on a stage of an inspection tool. The first substrate is then primarily aligned on the stage.

In step ST32, a laser is irradiated onto the first pattern to obtain a first light signal profile from a laser scattered from the first pattern. The first light signal profile is set up as a reference light signal profile in the inspection tool.

In step ST33, the first substrate is secondarily aligned to match the position of the first light signal profile with the reference light signal profile.

In step ST34, a second substrate having a second pattern is primarily aligned by a process substantially identical to that used for primarily aligning the first substrate.

In step ST35, a laser is irradiated onto the second pattern to obtain a second light signal profile from a laser scattered from the second pattern.

In step ST36, the second light signal profile is compared with the reference light signal profile.

In step ST37, whether or not the second light signal profile is within a predetermined acceptable predetermined range with respect to the reference light signal profile is determined.

In step ST38, when the second light signal profile is substantially identical to the first light signal profile, the second light signal profile may have the configuration substantially identical to that of the reference light signal profile. The second substrate is moved by a secondary alignment process to align a position of the second light signal profile with the reference light signal profile.

On the contrary, when the second light signal profile is substantially different from the reference light signal profile so that the second light signal profile is determined to be beyond the acceptable predetermined range, the reference light signal profile is exchanged for the second light signal profile with the second substrate being positioned on the stage. Thus, the second light signal profile is set up in the inspection tool as a new reference light signal profile.

In step ST40, the second substrate is minutely moved by a secondary alignment process to align a position of the second light signal profile with the new reference light signal profile. Additionally, after the second substrate is aligned, the above-mentioned steps are performed on following substrates.

According to the present embodiment, although a pattern of a substrate has a configuration different from that of the reference light signal profile, the second alignment process may be continuously performed using the new reference light signal profile obtained from the substrate. Thus, unloading the substrate from the inspection tool and repeatedly performing the first and second alignment processes may not be needed.

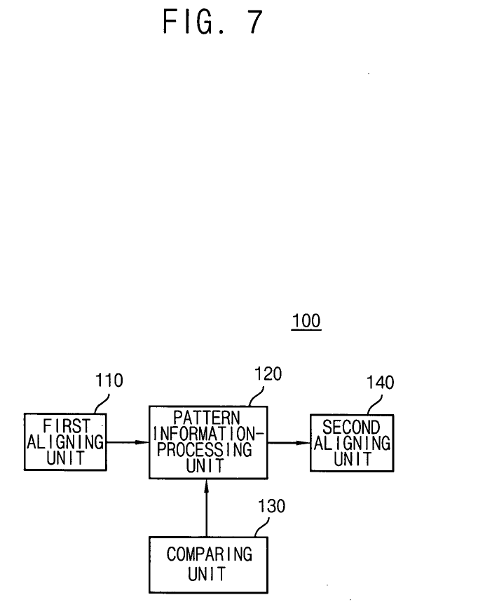

Referring to FIG. 7, an apparatus 100 for aligning a substrate includes a first aligning unit 110 for primarily aligning a substrate having a pattern. The first aligning unit 110 adjusts the position and the angle of the substrate.

A pattern information-processing unit 120 processes information with respect to the pattern. The pattern information such as the image or the light signal profile is inputted into the pattern information-processing unit 120. Also, reference pattern information is set up in the pattern information-processing unit 120.

A comparing unit 130 compares the pattern information with the reference pattern information. When the pattern information is beyond an acceptable predetermined range from the reference pattern information, the comparing unit 130 exchanges the reference pattern information for the pattern information.

A second aligning unit 140 secondarily aligns the substrate to match a position of the pattern with the pattern information.

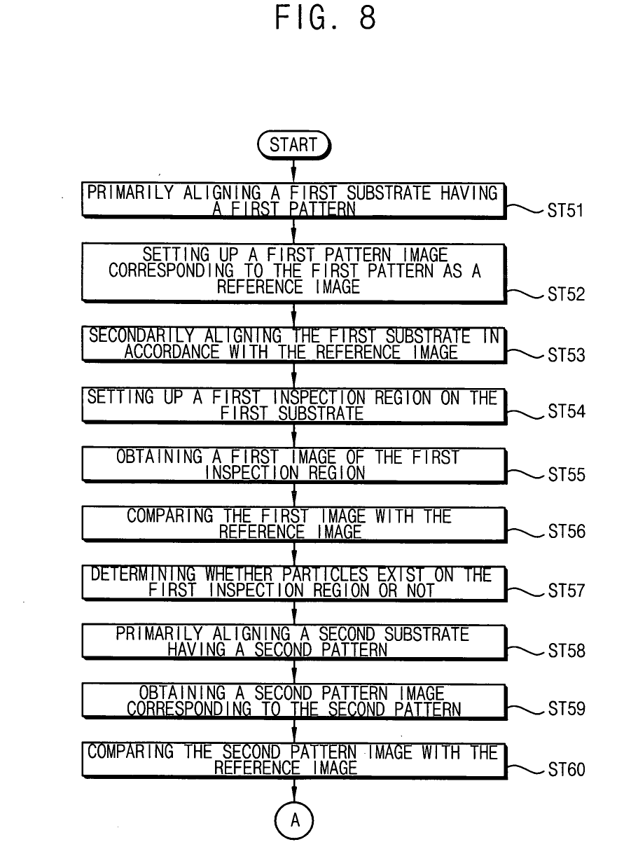

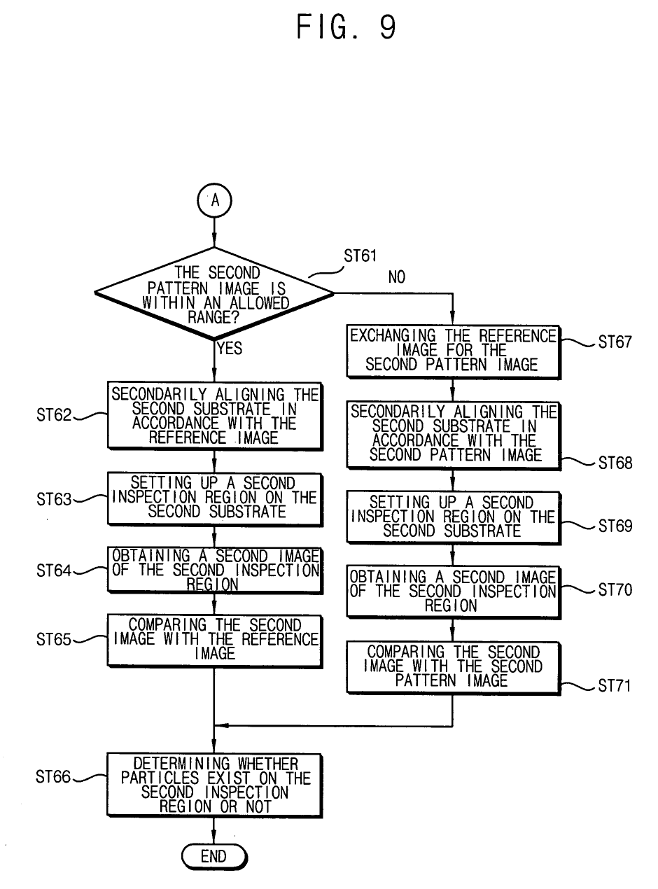

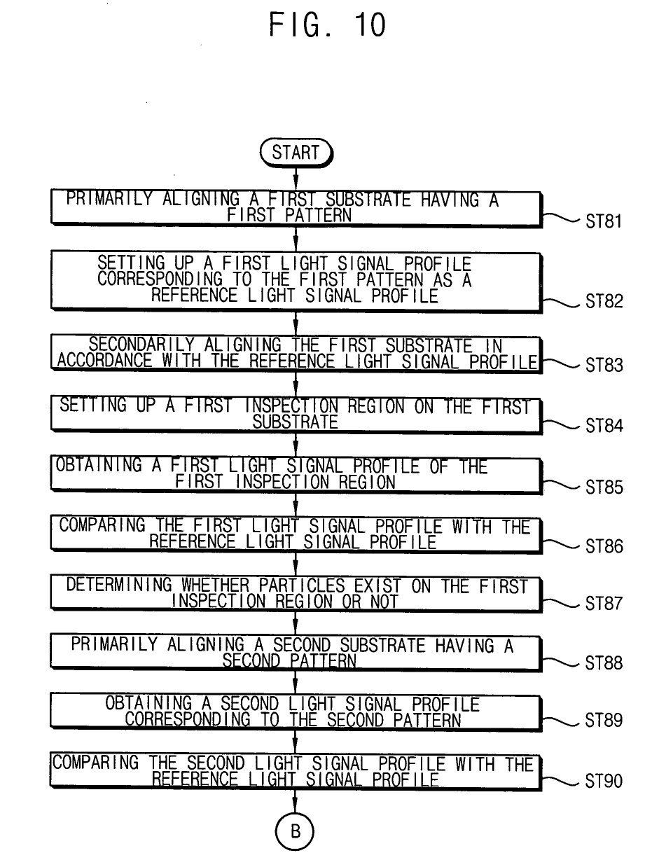

Referring to FIGS. 8 and 9, in step ST51, a first substrate having a first pattern is positioned on a stage of an inspection tool. The first substrate is then primarily aligned on the stage.

In step ST52, a first pattern image corresponding to the first pattern is obtained. The first pattern image is set up as a reference image in the inspection tool.

In step ST53, the first substrate is secondarily aligned to match the first pattern image with the reference image.

In step ST54, a first inspection region is set up on the first substrate.

In step ST55, a laser is irradiated onto the first inspection region to obtain a first image of the first inspection region from a laser reflected from the first inspection region.

In step ST56, the first image is compared with the reference image.

In step ST57, whether the number of particles on the first inspection region is within a predetermined acceptable range with respect to the reference image is determined in accordance with comparison results.

In step ST58, a second substrate having a second pattern is primarily aligned by a process substantially identical to that used for primarily aligning the first substrate.

In step ST59, a second pattern image corresponding to the second pattern is obtained.

In step ST60, the second pattern image is compared with the reference image.

In step ST61, whether the configuration of the second pattern image is within a predetermined acceptable range with respect to the reference image is determined.

In step ST62, when the configuration of the second pattern is within the acceptable predetermined range, the second substrate is moved by a secondary alignment process to align the position of the second pattern image with the reference image.

In step ST63, a second inspection region is set up on the second substrate.

In step ST64, a laser is irradiated onto the second inspection region to obtain a second image of the second inspection region from a laser reflected from the second inspection region.

In step ST65, the second image is compared with the reference image.

In step ST66, whether the numbers of particles on the second inspection region are within a predetermined acceptable range with respect to the reference image is determined in accordance with comparison results.

On the contrary, when the configuration of the second pattern image is greatly different from that of the reference image so that the configuration of the second pattern image is determined to be beyond the acceptable predetermined range, in step ST67, the reference image is exchanged for the second pattern image with the second substrate being positioned on the stage. Thus, the second pattern image is set up in the inspection tool as a new reference image.

In step ST69, a second inspection region is set up on the second substrate.

In step ST70, a second image corresponding to the second inspection region is obtained.

In step ST71, the second image is compared with the new reference image.

In step ST66, whether or not numbers of particles on the second inspection region is within a predetermined acceptable predetermined range with respect to the new reference image is determined in accordance with comparison results.

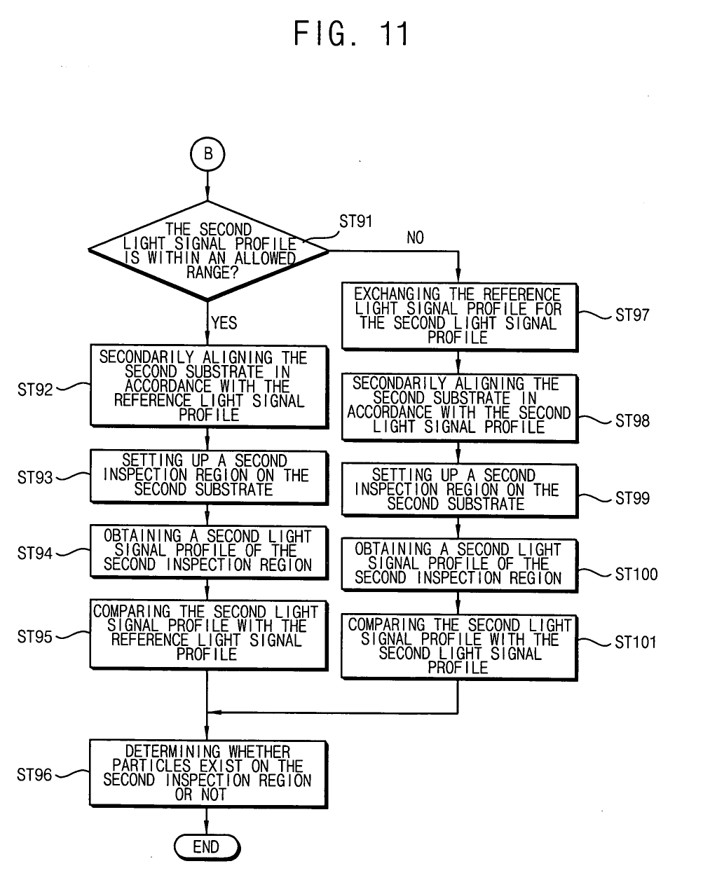

Referring to FIGS. 10 and 11, in step ST81, a first substrate having a first pattern is positioned on a stage of an inspection tool. The first substrate is then primarily aligned on the stage.

In step ST82, a first light signal profile corresponding to the first pattern is obtained. The first light signal profile is set up as a reference light signal profile in the inspection tool.

In step ST83, the first substrate is secondarily aligned to match the first light signal profile with the reference light signal profile.

In step ST84, a first inspection region is set up on the first substrate.

In step ST85, a first light signal profile corresponding to the first inspection region is obtained.

In step ST86, the first light signal profile is compared with the reference light signal profile.

In step ST87, whether or not numbers of particles on the first inspection region is within a predetermined acceptable predetermined range with respect to the reference image is determined in accordance with comparison results.

In step ST88, a second substrate having a second pattern is primarily aligned by a process substantially identical to that used for primarily aligning the first substrate.

In step ST89, a second light signal profile corresponding to the second pattern is obtained.

In step ST90, the second light signal profile is compared with the reference light signal profile.

In step ST91, whether or not the second light signal profile is within a predetermined acceptable predetermined range with respect to the reference light signal profile is determined.

In step ST92, when the second light signal profile is within the acceptable predetermined range, the second substrate is minutely moved by a secondary alignment process to align a position of the second light signal profile with the reference light signal profile.

In step ST93, a second inspection region is set up on the second substrate.

In step ST94, a second light signal profile corresponding to the second inspection region is obtained.

In step ST95, the second light signal profile is compared with the reference light signal profile.

In step ST96, whether or not numbers of particles on the second inspection region is within a predetermined acceptable range with respect to the reference light signal profile is determined in accordance with comparison results.

On the contrary, when the second light signal profile is greatly different from the reference light signal profile so that the second light signal profile is determined to be beyond the acceptable predetermined range, in step ST97, the reference light signal profile is exchanged for the second light signal profile with the second substrate being positioned on the stage. Thus, the second light signal profile is set up in the inspection tool as a new reference light signal profile.

In step ST99, a second inspection region is set up on the second substrate.

In step ST100, a second light signal profile corresponding to the second inspection region is obtained.

In step ST101, the second light signal profile is compared with the new reference light signal profile.

In step ST96, whether or not numbers of particles on the second inspection region is within a predetermined acceptable range with respect to the new reference light signal profile is determined in accordance with comparison results.

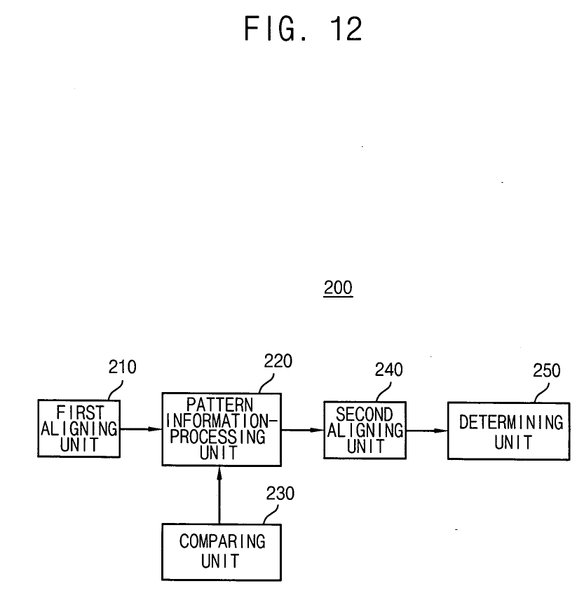

Referring to FIG. 12, an apparatus 200 for inspecting a defect on a substrate includes a first aligning unit 210 for primarily aligning a substrate having a pattern. A pattern information-processing unit 220 processes pattern information with respect to the pattern. A comparing unit 230 compares the pattern information with the reference pattern information. When the pattern information is beyond an acceptable predetermined range from the reference pattern information, the comparing unit 230 exchanges the reference pattern information for the pattern information. A second aligning unit 240 secondarily aligns the substrate to match a position of the pattern with the pattern information. A determining unit 250 recognizes a defect on the substrate based on the pattern information.

According to the present invention, when the pattern of a following substrate is beyond an acceptable predetermined range, the reference image is exchanged for the new pattern image. Thus, the following substrate passes the secondary alignment process without repeatedly performing the first and second alignment processes on the following substrate.

Having described the preferred embodiments of the present invention, it is noted that modifications and variations can be made in light of the above teachings. It is therefore to be understood that changes may be made in the particular embodiment of the present invention disclosed which is within the scope and the spirit of the invention outlined by the appended claims.

What is claimed is:

1. A method of aligning a substrate, comprising:
primarily aligning the substrate having a pattern;
obtaining pattern information corresponding to a configuration of the pattern;
comparing the pattern information with predetermined reference pattern information to corroborate the acceptability of the pattern information;
selectively exchanging the predetermined reference pattern information with the pattern information based on the acceptability of the pattern information; and
secondarily aligning the substrate to correlate the position of the pattern with the pattern information.

2. The method of claim 1, wherein primarily aligning the substrate comprises:
providing a plurality of first alignment points having a first width on the substrate;
moving the substrate to align the first alignment points with a predetermined first coordinate;
providing a plurality of second alignment points having a second width narrower than the first width on the substrate; and
moving the substrate to align the second alignment points with a predetermined second coordinate.

3. The method of claim 1, wherein the predetermined reference pattern information and the pattern information comprise an image or a light signal profile.

4. A method of aligning a substrate, comprising:
primarily aligning a first substrate having a first pattern;
obtaining reference pattern information corresponding to a configuration of the first pattern;
secondarily aligning the first substrate to correlate the position of the first pattern with the reference pattern information;
primarily aligning a second substrate having a second pattern;
obtaining pattern information corresponding to a configuration of the second pattern;
comparing the pattern information with the reference pattern information to corroborate the acceptability of the pattern information;
selectively exchanging the reference pattern information with the pattern information based on the acceptability of the pattern information; and
secondarily aligning the substrate to correlate the position of the pattern with the pattern information.

5. The method of claim 4, wherein primarily aligning the first and second substrates comprises:
setting up a plurality of first alignment points having a first width on the first and second substrates;
moving the first and second substrates to align the first alignment points with a predetermined first coordinate;
setting up a plurality of second alignment points on the first and second substrates having a second width narrower than the first width; and
moving the first and second substrates to align the second alignment points with a predetermined second coordinate.

6. The method of claim 4, wherein the reference pattern information and the pattern information comprise an image or a light signal profile.

7. An apparatus for aligning a substrate, comprising:
a first aligning unit for primarily aligning the substrate having a pattern;
a pattern information-processing unit for processing pattern information with respect to the pattern, reference pattern information being set up in the pattern information-processing unit;
a unit for comparing the pattern information with the reference pattern information to selectively exchange the reference pattern information for the pattern information; and
a second aligning unit for secondarily aligning the substrate to correlate the position of the pattern with the pattern information.

8. A method of inspecting a defect on a substrate, the method comprising:
primarily aligning the substrate having a pattern;
obtaining pattern information corresponding to a configuration of the pattern;
comparing the pattern information with predetermined reference pattern information;
exchanging the reference pattern information with the pattern information in accordance with comparison results;
secondarily aligning the substrate to correlate the position of the pattern with the pattern information; and
determining whether the defect exists on the substrate in accordance with the pattern information.

9. The method of claim 8, wherein the reference pattern information and the pattern information comprise an image, and
determining whether the defect exists on the substrate comprises:
setting up an inspection region on the substrate;
obtaining an image corresponding to the inspection region; and
comparing the image of the inspection region with the pattern information to determine whether the defect exists on the inspection region.

10. The method of claim 8, wherein the reference pattern information and the pattern information comprise a light signal profile, and
determining whether the defect exists on the substrate comprises:
setting up an inspection region on the substrate;
obtaining a light signal profile corresponding to the inspection region; and
comparing the light signal profile with the pattern information to determine whether the defect exists on the inspection region.

11. A method of inspecting a defect on a substrate, comprising:
primarily aligning a first substrate having a first pattern;
obtaining reference pattern information corresponding to a configuration of the first pattern;
secondarily aligning the first substrate to correlate the position of the first pattern with the reference pattern information;
determining whether the defect exists on the first substrate in accordance with the reference pattern information;
primarily aligning a second substrate having a second pattern;
obtaining pattern information corresponding to a configuration of the second pattern;
comparing the pattern information with the reference pattern information;
selectively exchanging the reference pattern information with the pattern information in accordance with the comparison results;
secondarily aligning the substrate to correlate the position of the pattern with the pattern information; and
determining whether the defect exists on the second substrate in accordance with the pattern information.

12. The method of claim 11, wherein the reference pattern information comprises an image, and
determining whether the defect exists on the first substrate comprises:
setting up a first inspection region on the first substrate;
obtaining a first image corresponding to the first inspection region; and
comparing the first image with the reference pattern information to determine whether the defect exists on the first inspection region.

13. The method of claim 11, wherein the reference pattern information comprises a light signal profile, and
determining whether the defect exists on the first substrate comprises:
setting up a first inspection region on the first substrate;
obtaining a first light signal profile corresponding to the first inspection region; and
comparing the first light signal profile with the reference pattern information to determine whether or not the defect exists on the first inspection region.

14. The method of claim 11, wherein the pattern information comprises an image, and
determining whether the defect exists on the second substrate comprises:
setting up a second inspection region on the second substrate;
obtaining a second image corresponding to the second inspection region; and
comparing the second image with the pattern information to determine whether the defect exists on the second inspection region.

15. The method of claim 11, wherein the pattern information comprises a light signal profile, and
determining whether the defect exists on the second substrate comprises:
setting up a second inspection region on the second substrate;
obtaining a second light signal profile corresponding to the second inspection region; and
comparing the second light signal profile with the pattern information to determine whether the defect exists on the second inspection region.

16. An apparatus for inspecting a defect on a substrate, comprising:
a first aligning unit for primarily aligning the substrate having a pattern;
a pattern information-processing unit for processing pattern information with respect to the pattern, reference pattern information being set up in the pattern information-processing unit;
a comparing unit for comparing the pattern information with the reference pattern information to selectively exchange the reference pattern information for the pattern information;
a second aligning unit for secondarily aligning the substrate to correlate the position of the pattern with the pattern information; and
a determining unit for determining whether the defect exists on the substrate in accordance with the pattern information.
